(19) United States
(12) Patent Application Publication
(10) Pub. No.: US 2004/0177610 A1
(43) Pub. Date: Sep. 16, 2004

(54) Broad range speed control for hydraulic motors

(76) Inventor: Barry M. Hendrickson, Arlington, TX (US)

Correspondence Address: JOHN F. BRYAN, P.O. BOX 1987, PLANO, TX, 75086, US

(21) Appl. No.: 10/386,006

(22) Filed: Mar. 11, 2003

(51) Int. Cl. F16D 31/02

(52) U.S. Cl. 60/489

(57) ABSTRACT

A variable speed control for closed loop hydrostatic drive has a variable displacement, pressure compensated, hydraulic piston pump of nominal capacity and a hydraulic motor of similar capacity with reversible inlet and outlet ports, connected to the pump inlet and outlet ports to operate in a closed loop for bidirectional rotation according to the pressure differential across the motor ports, and a proportional control valve, having a nominal flow capacity of no more than one-tenth the given pump output capacity, interposed between the pump and the motor to restrict and regulate oil flow through the relatively low pressure side of the loop for smooth, slow speed motor rotation, with a controller, connected to control the proportional valve for selection of a flow rate within its nominal capacity.

### TECHNICAL FIELD

The present invention relates to the field of fluid power control systems in general and more particularly, to systems for controlling hydraulic motor speeds in a closed loop system.

### BACKGROUND

Hydraulically controlled, variable speed hydrostatic pump/motor systems, operating in a power range of from 40 to 160 horsepower, have long been used in common practice. Both the pumps and motors comprise a plurality of pistons, which may be axially or radially arranged. The useful speed range of such a system is typically limited at both ends of the spectrum by the pump/motor performance characteristics. At the low end of the range of axial piston motors, generally at speeds under approximately 40 r.p.m, piston pulses and internal leakage cause motor output speed to surge and be incapable of smooth power delivery. Such surging is not a problem for accelerating from a start because torque is available and the output speed soon exceeds the critical 40 rpm level. The upper end of the speed range is usually a maximum of 5,000 rpm or somewhat more, according to bearing life requirements and other mechanical considerations. Generally speaking, higher speeds are attainable, but only at reduced load capacity, and lower speeds can be provided, but not with smooth speed control. Thus, a smooth high to low speed ratio in the order of 125:1

Radial piston motors have a smooth speed range of approximately 2-250 r.p.m. Again, the upper end of the speed range may be somewhat higher, according to bearing life requirements and other mechanical considerations. As is the case of axial piston motors, the high to low speed ratio for radial piston motors is in the order of 125:1 so that, regardless of motor type, this is about the broadest range that can be expected in a prior art closed loop hydraulic system.

A broader high/low ratio is desirable for example, in oilfield wire-line operations. Logging a well requires a smooth, slow speed in order to acquire accurate data. The slower the wire-line speed, as long as it is a consistent speed, the more accurate will be the data. A wire-line speed of 2′/min. would provide acceptable accuracy for logging at critical depth levels and even slower would be better. The speed problem is obvious when it is considered that the depth to be logged may be at 20,000 feet for example, so that with a time required to go in or come out of a deep well is very important. The 125:1 ratio means it will take a full hour and 20 minutes to come out from 20,000 ′ downhole and there will be similar large delays between readings taken at different levels. In this sort of application, a high/low speed ratio of 1000/1 is desireable. Variable displacement axial piston motors can provide a broader speed range speed, but still will not run smoothly below 40 r.p.m., so that a speed reduction gear-box is necessary to meet slow speed requirements. In such an arrangement the high speed range is severely diminished. Radial piston motors can be provided in a two-speed configuration, wherein its effective displacement is reduced by internal circuit changes. Even so, a radial piston motor needs a speed increasing gear-box to provide the higher output speeds, so that torque output is severely compromised. In any case, the realities of bearing life and mechanical speed limitations still apply. A suitably broad range control and power system might be provided electrically but, for well logging work, where the equipment is truck mounted for both off-road and over-the-road mobility, bulk and weight considerations rule out this option.

Other applications for broad speed range hydrostatic drives are found in the propelling drive of trenchers, ditching machines, excavating machines, mining machines and the like, which require a slow working speed, often less than 1′/minute, and a much faster travel speed, for moving from one site to the next. Conventional motor control systems for a working speed under 1′/min. will have a maximum travel speed in the order of 100′/minute. Since a normal walking speed is 330′/minute, it is obvious that a higher speed, in the order of 1,000′/minute is needed. For this reason, separate working and traveling drives are usually provided, at considerable expense. Another option to broaden the speed range capability is to add a mechanical speed reducer to the drive line, so that the conventional 125:1 hydrostatic ratio is augmented by a mechanical speed reducer, with a ratio of 8:1 or thereabout. Because of high speed mechanical limitations of such a unit, it must be disengaged in the traveling speed mode. This requirement introduces the added complexity and expense of a countershaft and some type of engaging and disengaging mechanism.

A first object of the present inventions is therefore, to provide a hydrostatic drive system with high speed/low speed ratio capability in the order of 1,000:1 A second object of the present inventions is to provide this hydrostatic drive system in a form that maintains adequate torque output at high speeds. A third object of the present inventions is to provide this hydrostatic drive system in a form that permits the use of commercially available components. A fourth object is to provide the present inventions in a form that does not require any of these commercially available components to operate at loads, pressures, volumes or speeds in excess of those specifically approved by their manufacturer. Yet other objects are simplicity of operation and ease of maintenance.

### SUMMARY OF THE INVENTIONS

The present inventions address the aforementioned objectives by the provision of a hybrid control circuit for a closed loop hydrostatic drive system. A two-speed, radial piston motor or a variable speed axial piston motor allows operation at either full or one-half displacement and the motor is sized so that one-half displacement provides adequate torque at the higher rotating speeds. This allows the motor output speed to be doubled or halved for any given fluid input volume as the operation requires. The effective displacement of the radial motor is shifted by internal circuit changes. The displacement of the axial motor is changed by shifting the motor swash plate position from the full displacement angle to a preset one-half displacement angle by means of an external cylinder. As mentioned above, the bearing life and mechanical limitations still apply in the high-speed operating mode. A preferred embodiment of the present inventions uses a variable displacement pump, with a nominal maximum capacity of approximately 50 g.p.m. and a two-speed motor of similar size. The pump and motor are connected in a conventional closed loop hydraulic system for the third and fourth speeds, the upper ranges, wherein fourth speed is acquired by shifting the motor to one-half displacement. The loop is reconfigured according to the present inventions to provide the low speed first and second ranges, wherein second speed is acquired by shifting the motor to one-half displacement. Thus, first and third speed ranges are respectively doubled to provide the second and fourth speed ranges. In this manner, a maximum motor speed of 72 rpm in the first speed range is increased to 144 rpm in second speed and a maximum motor speed of 2,500 rpm in the third speed range is increased to 5,000 rpm in fourth speed.

The circuitry for the first and second, low speed ranges is related to the closed loop, third and fourth speed circuitry, but revised by shifting three solenoid operated valves.

The first of these solenoid operated valves reroutes the joystick control outputs from the pump swash-plate positioning control to the pilot operated control of a proportional valve having a nominal flow capacity of approximately 1.5 g.p.m. A proportional valve will receive a pilot pressure signal and move the valve spool against a spring to allow flow through the valve in proportion to the pilot signal pressure level. In this manner, a valve with a nominal capacity of 1.5 g.p.m. will allow a flow rate of 0.75 g.p.m., with a pilot signal pressure equal to 50% of full range pressure. A proportional valve is a four-way valve, which may be designed to meter either input flow or output flow. In closed loop systems motor speed is virtually always controlled by varying pump displacement. If a fluid flow metering device is used to control motor speed in any system, open or closed loop, the device used to meter input flow from the high pressure source, while the low pressure return flow is relatively unrestricted for the previously stated reasons.

The second solenoid operated valve puts pump operation in a pressure compensated, load sensing mode and the third solenoid operated valve directs the pump inlet and output flows to blocked pressure and return ports of the proportional flow control valve. The proportional flow control valve circuit is introduced into the closed loop to restrict and regulate the flow of oil from the motor, rather than to the motor, for control of motor speed in either direction of rotation. These control techniques, used in conjunction with varying the engine speed between 1,100 rpm to 1,800 rpm, provide a smooth operating range of 4-72 rpm in first speed; 8-144 rpm in second speed; 40-2,500 rpm in third speed and 40-5,000 rpm in fourth speed.

Not only is the hydraulic control circuitry of the present inventions unique, but also unique is the concept of regulating return flow for motor speed control, as is typical in the prior art. Initial efforts to develop the motor control system of the present inventions used a conventional “meter in” proportional valve and yielded erratic slow speed characteristics, similar to prior art systems, albeit at slower speeds, because the low flow rate proportional valve eliminated pump irregularities from the equation. Through experimentation it was determined that smooth, slow motor speeds could be achieved by use of a “meter out” proportional valve to restrict and regulate the outflow of low-pressure fluid from the motor. This is a radical departure from the accepted practice of metering high-pressure input flow for motor speed control. Conventional practice would not have the motor return flow at a pressure higher than loop charge pressure. This is possibly because motor output torque is a function of the pressure drop across the motor work ports. Thus, if return fluid pressure is not predictable, motor output torque performance can not be predicted as a direct function of motor inlet pressure. Increasing motor outlet pressure also causes greater internal leakage and a drop in motor efficiency. These supposed “negatives” conspire to make the present invention unobvious to those of ordinary skill in the fluid power arts. Thus, contrary to the long standing expectations of others skilled in the art, the motor of this invention can rotate smoothly, at speeds as slow as 4 rpm, while providing a high/low speed range ratio of 1,250:1. In this manner, wire-line or working speeds as slow as 0.7′/min. are consistent with tripping or travel speeds of 880′/min (10 mph.). It is notable that, if motor speed is the only consideration, third speed overlaps with second speed at the low end and fourth speed at the high end, and might be thought to be dispensable. However, in applications such as traveling speed drives, this range provides a useful combination of torque and speed capabilities.

Thus, the present inventions provide the unique capability of being able to provide a finely metered, low volume fluid flow for operation of a relatively large displacement hydraulic motor at very slow speeds, consistent with retention of motor displacement to deliver adequate output torque at very high speeds.

### BRIEF DESCRIPTION OF THE DRAWINGS

The accompanying drawings are incorporated into the specification to assist in explaining the present inventions. The drawings illustrate preferred and alternative examples of how the inventions can be made and used and are not to be construed as limiting the inventions to only those examples illustrated and described. The various advantages and features of the present inventions will be apparent from a consideration of the drawings in which:

FIG. 1 is a schematic circuit diagram for a preferred embodiment of the first speed mode of the present inventions;

FIG. 2 is a schematic circuit diagram for a preferred embodiment of the second speed mode of the present inventions;

FIG. 3 is a schematic circuit diagram for a preferred embodiment of the third speed mode of the present inventions; and

FIG. 4 is a schematic circuit diagram for a preferred embodiment of the fourth speed mode of the present inventions.

### DETAILED DESCRIPTION OF THE DRAWINGS

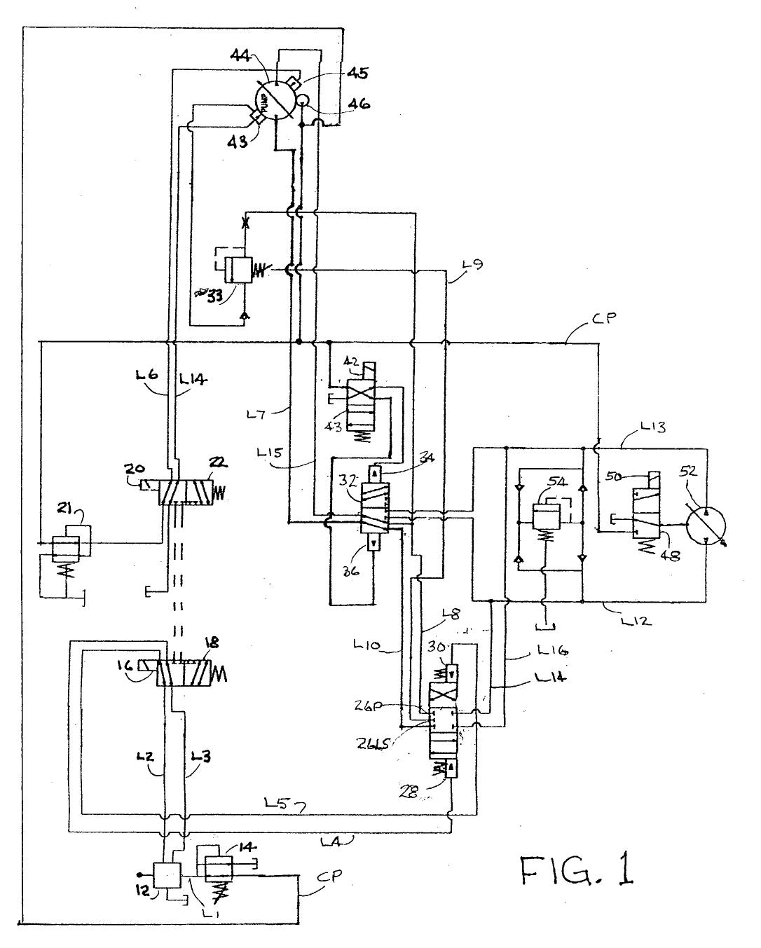

The present inventions are described in the following by referring to drawings of examples of how the inventions can be made and used. In these drawings, reference characters are used throughout the views to indicate like, or corresponding parts. The the art, and as such are neither shown nor described. Each of the circuits illustrated in FIGS. 1-4 and described below shows dashed lines to represent the inactive circuit connections for that specific configuration.

FIG. 1 is circuit diagram showing the present inventions for the connection and control of variable displacement hydraulic pump 44 and two-speed hydraulic motor 52 in a closed loop system, to provide the slowest, smooth operating motor speed range of from 4 to 72 r.p.m. The ports of pump 44 and motor 52 may operate at either a relatively high or low pressure, according to the direction of motor rotation, as is typical of closed loop hydrostatic drives. Variable displacement hydraulic pump 44 includes charge pressure pump 46 for supply of leakage make-up fluid to the circuit and for provision of control circuit operating pressure as noted at the circuit connections labeled CP. Fine speed control, shown here as a pressure relief valve 14, which might also be a voltage dropping device such as an electric rheostat in another embodiment, provides for an adjustable signal, routed via line L1 to joystick directional control 12. Directional control might be provided by a double throw switch in the aforesaid other embodiment. The pressure signal set at speed control 14, and the fluid return to tank, flow through lines L2 and L3 to double selector valve 18, as set by actuation of solenoid 16. In this case, double selector valve 18 connects the pressure signal to pilot port 28 of proportional control valve 26 via line L4 and the return line to pilot port 30 via L5. Proportional control valve 26 in this preferred embodiment has a nominal capacity of 1.5 g.p.m. and, in no case should have a nominal capacity more than one-fifth that of the motor. The through-put at any time is proportional to the displacement of the valve spool. In the aforesaid other embodiment, spool position may be controlled in the same manner by an electric voltage signal. At this time, solenoid 20 is also actuated to shift double selector valve 22 so as to direct the pressure signal determined by relief valve 21 to pump control piston 45 via line L6. In this setting, variable displacement pump 44 delivers oil under pressure to double selector valve 32 via line L15. Here, venting of pilot port 34, resulting from actuation of solenoid 42, shifts the valve spool so that the oil flow is routed to port 26P of valve 26 via line L8. The flow through proportional valve 26 is metered according to the spool displacement resulting from the pressure output of fine speed control 14 working against the pilot centering springs of valve 26. Under these conditions, wherein variable displacement pump is delivering pressurized fluid to an essentially blocked port, pump pressure compensates at the pressure setting of relief valve 33. This pressure setting is controlled by a pressure feedback signal from load sensing port 26LS of proportional valve 26. This signal pressure is routed through line L9 to the spring chamber of relief valve 33, to increase the pressure output of variable displacement pump 44 as operating conditions dictate. The outlet and return ports of proportional valve 26 connect to the directional ports of two-speed motor 52 via lines L10 and L11. The ports of motor 52 are connected to always route the return flow through the volume controlled port of proportional valve 26 via line L10 or L11, so that its rotational speed is always governed by back pressure on the return port of motor 52. Relief valve 54 is connected across ports of motor 52 to protect pump 44 and motor 52 from overload conditions.

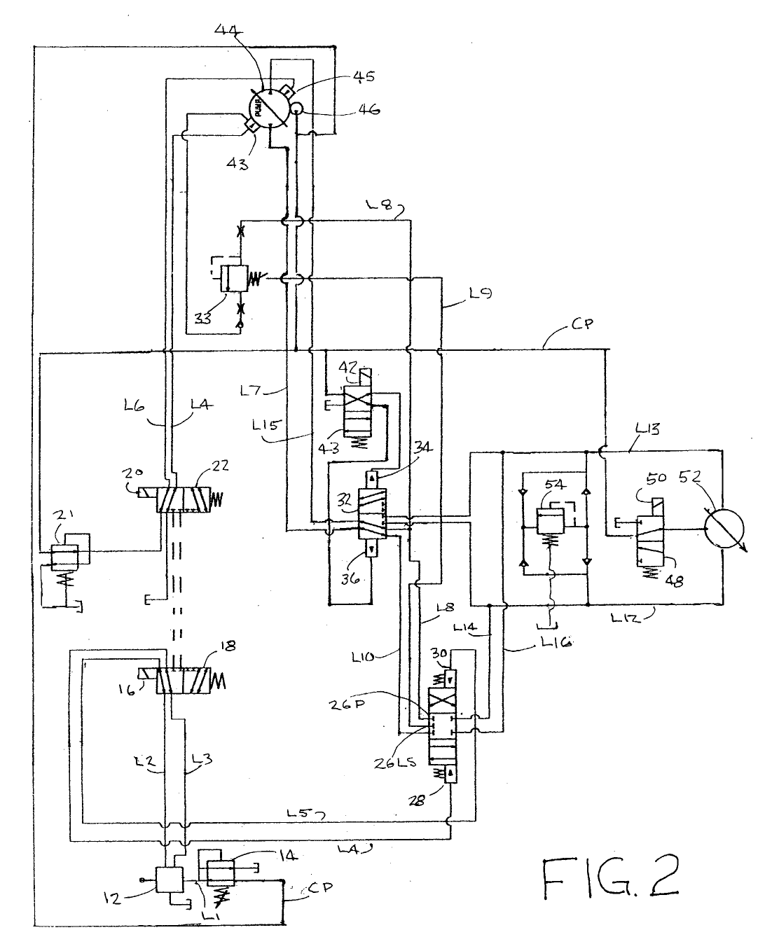

FIG. 2 is a schematic diagram of the second low speed range configuration of the present inventions, which is the same as the configuration of FIG. 1 in all respects, except that solenoid 50 is actuated to select the one-half displacement configuration of two speed motor 52. With this change, the speed range achieved by this configuration is essentially doubled, with respect to the configuration of FIG. 1, giving a smooth operating range of from 8 to 144 r.p.m.

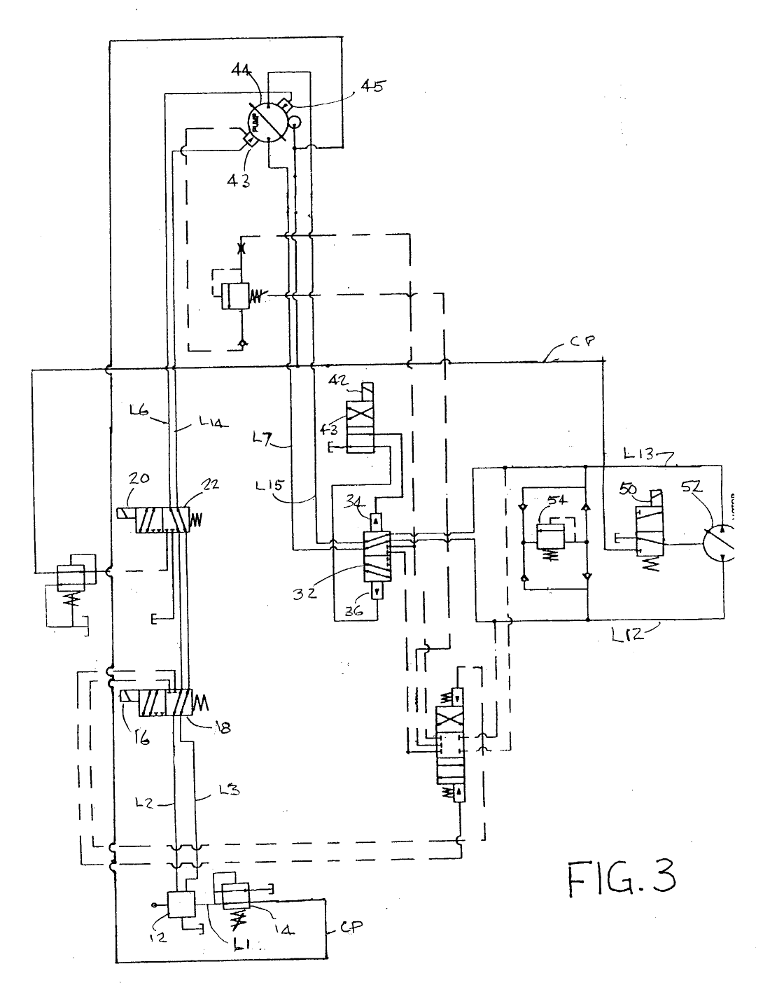

FIG. 3 is circuit diagram showing the present inventions as they appeared when reconfigured to function as a conventional closed loop, with variable displacement hydraulic pump 44 and two-speed hydraulic motor 52, to provide the higher speed ranges. It should be noted that all four solenoids 16, 20, 42 and 50 are inactive. In this condition, the fluid pressure set at fine speed adjusting valve 14 provides flow via line L1, to joystick control 12. This fluid pressure and a tank return are routed directly through selector valves 18 and 22 via lines L2 and L3, where L3 and L2 alternately conduct the fluid pressure signal or the fluid return flow, depending upon the directional setting of joystick control 12. Lines L6 and L14 are thus, connected to lines L2 and L3 respectively, so that joystick 12 displaces pump displacement controllers 43 and 45 to control volume and flow direction of pump 44. The closed loop inlet and outlet flows of pump 44 connect to double selector valve 32 by lines L7 and L15. Deactivation of solenoid 42 shifts double selector valve 32 to direct flow to lines L12 and L13, completing the closed loop powering motor 52. In this configuration, the speed of motor 52 is determined directly by the pump output flow, as controlled by joystick 12, in combination with the pump driven speed, per the engine governor setting, giving a smooth operating range of from 40 to 2,500 r.p.m.

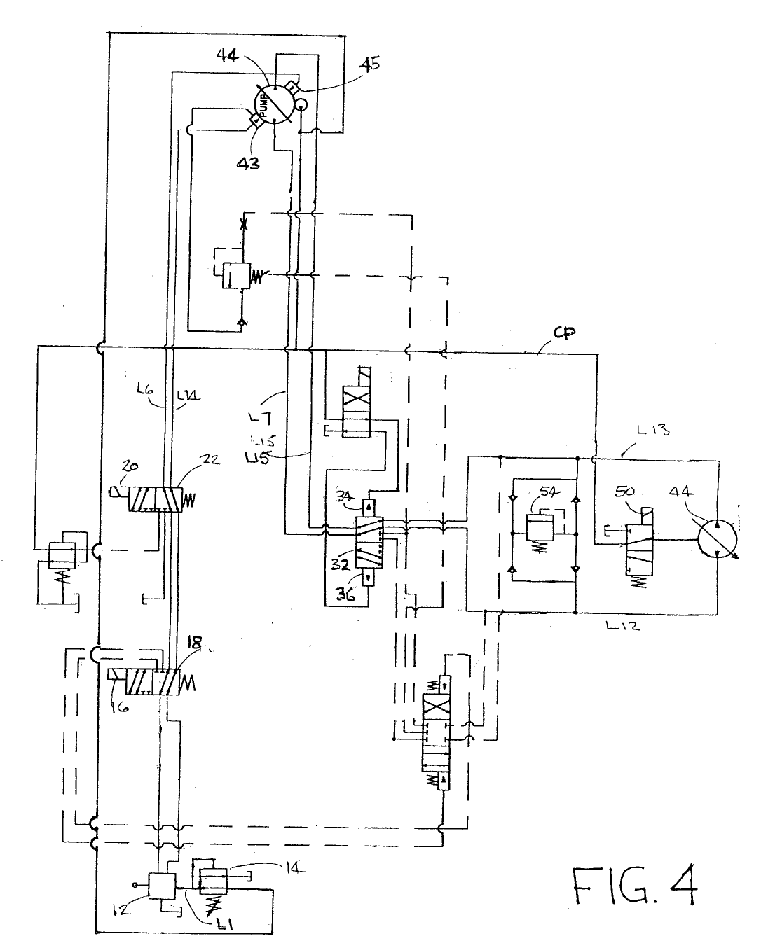

FIG. 4 is a schematic diagram of the fourth, highest speed range configuration of the present inventions, which is the same as the configuration of FIG. 3 in all respects, except that solenoid 50 is actuated to select the one-half displacement configuration of two speed motor 52. This change alters the circuit, so that the speed range is essentially doubled, with respect to the configuration of FIG. 3, giving a smooth operating range of from 40 to 5,000 r.p.m.

As described above, the present inventions provide the unique capability of being able to provide a finely metered, low volume fluid flow for operation of a relatively large displacement hydraulic motor at very slow speeds, consistent with retention motor displacement, so as to deliver adequate output torque at very high speeds.

The embodiments shown and described above are exemplary. It is not claimed that all of the details, parts, elements, or steps described and shown were invented herein. Even though many characteristics and advantages of the present inventions have been described in the drawings and accompanying text, the description is illustrative only. Changes may be made in the details, especially in matters of shape, size, and arrangement of the parts within the scope and principles of the inventions. The restrictive description and drawings of the specific examples above do not point out what an infringement of this patent would be, but are to provide at least one explanation of how to use and make the inventions. The limits of the inventions and the bounds of the patent protection are measured by and defined in the following claims.

I claim:

1. A variable speed control for closed loop hydrostatic drives comprising:
a variable displacement, pressure compensated, hydraulic piston pump having a given maximum output flow capacity, with reversible outlet and inlet ports and driven to supply oil to the outlet port at relatively high pressures and receive oil at the inlet port at relatively low pressures;
a hydraulic motor of a given displacement and flow capacity, with reversible inlet and outlet ports, connected to the pump inlet and outlet ports to operate in a closed loop for rotation in a working direction and a non-working direction, as driven by the differential between the relatively high and relatively low pressures of the hydraulic piston pump;
a proportional control valve, having a nominal flow capacity of no more than one-fifth the given motor capacity, interposed between the pump and the motor to restrict and regulate oil flow through the relatively low pressure side of the loop for a given direction of rotation as relatively high pressure is maintained in the other side of the loop; and
a valve controller, connected to position the proportional valve for a selected flow rate within its nominal capacity.

2. A variable speed control for closed loop hydrostatic drives according to claim 1 wherein the valve controller comprises a manually operated remote control.

3. A variable speed control for closed loop hydrostatic drives according to claim 1 wherein the valve controller comprises a hydraulic signal.

4. A variable speed control for closed loop hydrostatic drives according to claim 1 wherein the valve controller comprises an electric signal.

5. A variable speed control for closed loop hydrostatic drives according to claim 1 wherein the motor has the capability of operating at either a high or a low speed on a given pump flow volume.

6. A variable speed control for closed loop hydrostatic drives according to claim 1 and further comprising:
a first double selector valve connected to reconfigure the pump output control from pressure compensated to pilot control operated;
a second double selector valve connected to divert the manual control inputs from the proportional valve to the pump pilot controls; and
a third double selector valve connected to divert the pump flow from the proportional valve directly to the motor, so as to provide a significantly higher motor speed capability.

7. A variable speed control for closed loop hydrostatic drives according to claim 1 wherein the motor has the capability of operating at reduced displacement to provide a higher speed range.

8. A variable speed control for closed loop hydrostatic drives according to claim 6 wherein the motor has the capability of operating at reduced displacement to provide two speed ranges.

9. A variable speed control for closed loop hydrostatic drives comprising:
a variable displacement, pressure compensated, hydraulic piston pump having a given maximum output flow capacity, with reversible outlet and inlet ports and driven to supply oil to the outlet port at relatively high pressures and receive oil at the inlet port at relatively lo pressures;
a hydraulic motor, with reversible inlet and outlet ports, connected to the pump inlet and outlet ports to operate in a closed loop for rotation in a working direction and a non-working direction, as driven by the differential between the relatively high and relatively low pressures of the hydraulic piston pump;
a proportional control valve responsive to an adjustable remote signal and having a nominal flow capacity of no more than one-fifth the given pump output capacity, interposed between the pump and the motor to restrict and regulate oil flow through the relatively low pressure side of the loop for a given direction of rotation as relatively high pressure is maintained in the other side of the loop;
a remote signal source, connected to position the proportional valve for selecting a flow rate within its nominal capacity;
a remotely actuated first double selector valve connected to reconfigure the pump output control from pressure compensated to pilot piston operated;
a remotely actuated second double selector valve connected to divert pump flow control signals from the proportional valve to the pump pilot pistons;
a remotely actuated third double selector valve connected to divert the pump flow from the proportional valve directly to the motor; and
a remote actuator to control first, second and third double selector valve so as to selectively provide low and high motor speed ranges.

10. A variable speed control for closed loop hydrostatic drives according to claim 9 wherein the remote signal source comprises a manually operated control.

11. A variable speed control for closed loop hydrostatic drives according to claim 9 wherein the remote signal source provides a hydraulic signal.

12. A variable speed control for closed loop hydrostatic drives according to claim 9 wherein the remote signal source provides an electric signal.

13. A variable speed control for closed loop hydrostatic drives according to claim 9 wherein the motor has the capability of operating at either a high or a low speed on a given pump flow volume.

14. A variable speed control for closed loop hydrostatic drives according to claim 9 wherein the motor has the capability of operating at reduced displacement to provide two speed ranges.
